(19) United States
(12) Patent Application Publication
(10) Pub. No.: US 2023/0368268 A1
(43) Pub. Date: Nov. 16, 2023

(54) MULTI-MODAL MACHINE LEARNING MODEL AND SYSTEM

(71) Applicant: Target Brands, Inc., Minneapolis, MN (US)

(72) Inventors: MIN WANG, Sunnyvale, CA (US); ATA MAHJOUBFAR, Sunnyvale, CA (US); ANUPAMA JOSHI, Sunnyvale, CA (US)

(73) Assignee: Target Brands, Inc., Minneapolis, MN (US)

(21) Appl. No.: 18/317,593

(22) Filed: May 15, 2023

Related U.S. Application Data
(60) Provisional application No. 63/341,695, filed on May 13, 2022.

(51) Int. Cl. G06Q 30/06

(52) U.S. Cl. CPC G06Q 30/0631; G06Q 30/0627; G06Q 30/0629; G06Q 30/0643

(57) ABSTRACT

A multi-modal machine learning model is disclosed that may be implemented in a recommender system. The model may generate a multi-modal embedding based on a user query, one or more user-selected items, and a conversation history. The one or more user-selected items may include text data and visual data. In some embodiments, the recommender system may use the multi-modal embeddings to recommend one or more items of a plurality of items. In some embodiments, the multi-modal model may be integrated with other systems.

### RELATED APPLICATIONS

This application claims priority to U.S. Provisional Patent Application Ser. No. 63/341,695 filed on May 13, 2022, entitled “Designing a Visual Question Answering System for Fashion,” which is hereby incorporated by reference in its entirety.

### BACKGROUND

An item may be associated with a variety of data. For example, an item may be associated with visual information (e.g., images) and textual information (e.g., a title, description, and attributes). A computer system may not effectively use the various types of data associated with an item. As a result, computer technology-such as, for example, chat bots, search tools, recommender systems, labeling tools, data storage systems, and so on-may be suboptimal. For instance, such a tool may not appropriately account for all available information of an item or may not accurately weigh the relative importance of such information. Yet still, such computer tools may also fail to account for other contextual information when performing a task, information such as user queries, historical data, or other conditions.

As an example, fashion is about 2% of the world’s GDP and a significant sector of the retail industry. Whenever a new fashion item like apparel or footwear is launched, the retailer needs to prepare and show rich information about the product, including pictures, text descriptions, and detailed attribute tags. The attributes of the fashion products, including color, pattern, texture, material, occasion-to-use, etc., require domain experts to label them piece by piece. This labeling process is time-consuming, costly, subjective, error-prone, and fundamentally imprecise due to the interdependency of the attributes. Because labeling of data can be a time-consuming process, it is often difficult to develop and train robust, accurate models that can answer questions in a visual question answering context.

### SUMMARY

Aspects of the present disclosure relate to a multi-modal machine learning model that may be trained to receive textual and visual data and output multi-modal embeddings. The multi-modal embeddings may be used in various downstream systems, such as a search tool, labeling tool, ranking tool, or a recommender system. In some instances, the multi-modal embeddings may be used to select items. In the context of a recommender system, the recommender system may use the multi-modal model to generate multi-modal embeddings based on a user-preferred item, a user history, and a conversation history. The recommender system may then compare the multi-modal embeddings to embeddings generated for a collection of items.

In a first aspect, a method for recommending items is disclosed. The method comprises generating, using a multi-modal machine learning model, a collection of embeddings for a collection of items; receiving a selection of an item, the item including an item image and item text; receiving a user query; determining a first embedding for the selected item based at least in part on the item image and the item text; determining a second embedding for the user query; determining a third embedding for a conversation history, the conversation history including a previous user query and a previously selected item; inputting the first embedding, the second embedding, and the third embedding into the multi-modal machine learning model to generate a target embedding; determining similarities between the target embedding and embeddings of the collection of embeddings; and based on the similarities, recommending an item of the collection of items.

In a second aspect, a recommender system is disclosed. The recommender system comprises a multi-modal machine learning model; a processor; and memory storing instructions that, when executed by the processor, cause the recommender system to: generate, using the multi-modal machine learning model, a collection of embeddings for a collection of items; display a user interface; receive a selection of an item via the user interface; receive a user query via the user interface; select, from the collection of embeddings, a first embedding for the selected item; determine a second embedding for the user query; determine a third embedding corresponding to a conversation history, the third embedding being a previous target embedding; input the first embedding, the second embedding, and the third embedding into the multi-modal machine learning model to generate a target embedding; determine similarities between the target embedding and embeddings of the collection of embeddings; and based on the similarities, recommend an item of the collection of items; display the recommended item via the user interface.

In a third aspect, a multi-modal machine learning system is disclosed. The system comprises a processor and a memory storing instructions that, when executed by the processor, cause the multi-modal machine learning system to: generate labeled domain-specific training data based at least in part on data from a product catalog; train a multi-modal machine learning model using the labeled domain-specific training data; receive text data and visual data; generate, using a language encoder, text embeddings for the text data; generate, using a visual encoder, visual embeddings for the visual data; input the text embeddings and the visual embeddings into the multi-modal machine learning model; receiving, from the multi-modal machine learning model, multi-modal embeddings corresponding to the text data and the visual data; and inputting the multi-modal embeddings into a task-specific output layer associated with a downstream system.

### BRIEF DESCRIPTION OF THE DRAWINGS

FIG. 1 illustrates a block diagram of example implementations of a multi-modal model.

FIG. 2 illustrates an example network environment for training a multi-modal model.

FIG. 3 is a flowchart of an example method for configuring a multi-modal model.

FIG. 3A illustrates an example visualization of attention of an intermediate layer of an embodiment of the multi-modal model.

FIG. 3B illustrates an example visualization of attention of an intermediate layer of an embodiment of the multi-modal model.

FIG. 4 is a flowchart of an example method for generating training data.

FIG. 5 illustrates an example network environment in which a recommender system may be implemented.

FIG. 6A is a flowchart of an example method that may be performed by a recommender system.

FIG. 6B is a flowchart of an example method that may be performed by a recommender system.

FIG. 7 illustrates a schematic diagram of example operations of a recommender system.

FIG. 8A illustrates aspects of an example recommendation session.

FIG. 8B illustrates aspects of an example recommendation session.

FIG. 8C illustrates aspects of an example recommendation session.

FIG. 9 illustrates an example network environment in which a search tool may be implemented.

FIG. 10 illustrates an example computing system with which aspects of the present disclosure may be implemented.

### DETAILED DESCRIPTION

As briefly described above, aspects of the present disclosure relate to a multi-modal machine learning model that receives text and image data and that generates embeddings (e.g., vectors). The embeddings generated by the model may reflect the context in which the text and images are used. For example, the numerical values that make up the embeddings may be altered based on the learned weights of the multi-modal model and based on details of the text and input data. In examples, the model may be a pre-trained visual language model that is fine-tuned for a particular task or for a particular domain.

In example aspects, the model may be fine-tuned for use in a multi-modal recommender system. As part of a recommender system, the model’s input may include embeddings for a text query, selected items (e.g., item image data and textual data, such as item attributes), and a conversation state. The conversation state may be a previously generated target embedding that incorporates previously recommended items and previous user queries. Based on these inputs, the model may output a target embedding in a latent space. In the latent space, the recommender system may compare the target embedding to embeddings for a collection of items, embeddings that the model may have previously determined. In examples, the recommender system may recommend the items having embeddings closest to the target embedding in the latent space.

In example aspects, the model may be fine-tuned in other manners. For example, in the context of the recommender system, the model may be fine-tuned to apply time-dependent weights on previous conversation states. For instance, during fine-tuning, the model may learn that applying a greater weight to a temporally near conversation state and a lesser weight to a temporally distant conversation state results in better recommendations, based, for example, on labeled training data, such as past recommendation sessions. As another example, the model may be fine-tuned for a specific domain of visual-language data, such as fashion, clothing, or retail products more generally. As another example, the model may include an ensemble of models, such as a text-based model and an image-based model. As another example, the model may be fine-tuned for other tasks, such as searching, ranking, visual question answering (VQA), or labeling tasks.

In example aspects, aspects of the present disclosure include generating labeled training data. For example, visual attributes of fashion items may be used to create a large-scale dataset that may be used to train the multi-modal model. The large-scale dataset may be formed from a plurality of question-answer-image triplets, which may include both positive and negative examples of queries that may be submitted against the data set. Positive examples may be derived using a question template and combinations of images and image attributes. Forming the dataset can include querying a unique identifier for each of a plurality of unique fashion items, and defining a data structure configured to query meta-information of each of the plurality of unique fashion items. Forming the dataset may also include, for each of the plurality of unique fashion items, populating a question template with specific attribute values and category information to generate one or more questions associated with each image.

In example aspects, the dataset that is generated enables rapid training of a model for domain-specific inference. In examples, the model may be adapted for use in a retail website to perform a retail-related task, such as answering a wide variety of questions. That is, search queries submitted to a retail website may be reformulated and answered using the model. The search queries may be reformulated according to the templates used to generate training data. In some examples, rather than reformulating the search queries into questions, raw embeddings of user queries, and any selected items (including textual and visual information for such items), may be input into the model.

Certain embodiments of the present disclosure have technical features that make them particularly advantageous over existing tools. For example, the model may generate embeddings that reflect nuance in textual and visual data, because the model may be based on a large-scale model trained on vast amounts of data while also being fine-tuned, in some embodiments, for a particular domain. By incorporating these embeddings in downstream tasks, such as an interactive recommender system, search tool, or automated labeling tool, the accuracy, precision, and generalizability of these system and tools may be improved. For example, a recommender system may, across multiple iterations, account for a user query, text and visual data for user-selected items, and a previous conversation state, resulting in an interactive shopping experience that is automated, extensible, and intuitive. In some embodiments, the recommender system is extensible because it may easily add or remove items and because many users may simultaneously use it. In some embodiments, the recommender system is intuitive because of the back-and-forth conversational flow provided by the recommender system.

Additionally, the recommender system may account for previous conversation states, which may include previous items selected by a user, previous user queries, and previously recommended items. As a result, the recommender system may have a mechanism for remembering previous aspects of an interaction, unlike recommender systems that have a limited or non-existent memory. Such a memory mechanism may allow a user to narrow down a search to items having certain characteristics, even if the user is unaware of item classifications or hierarchies or is even unaware of what types of items are available.

Further advantages of the present disclosure include that the embeddings generated by a multi-modal model may be used in other downstream tasks, such as labeling item attributes, searching, or visual question answering. Yet still, aspects of the present disclosure may result in improved accuracy and precision of machine learning models for retail-specific applications, given the generation of a large retail-specific dataset and the use of such a dataset to fine-tune a large vision language model. As will be apparent, there are only some of the advantages offered by the aspects of the present disclosure.

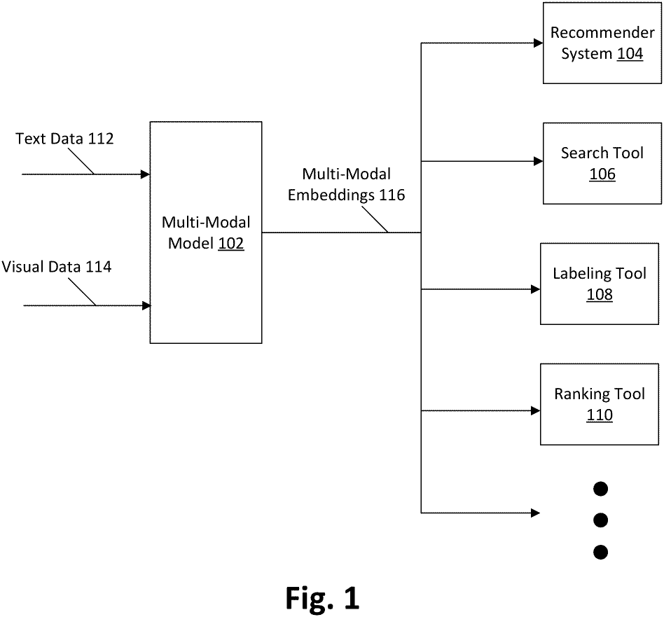

FIG. 1 illustrates a block diagram of example uses of a multi-modal model 102. In the example of FIG. 1, the model 102 is implemented in connection with various downstream systems, including a recommender system 104, a search tool 106, a labeling tool 108, and a ranking tool 110. In some embodiments, a different version of the model 102 may be used for each of the downstream services. For example, the model 102 may be fine-tuned differently depending on the downstream service with which it is operating. In examples, the input, output, or structure of the model 102 may vary depending on the fine-tuning process and depending on the downstream task with which the model 102 is used. In some embodiments, one or more of the downstream systems 104-110 may include layers that are appended onto the model 102 during fine-tuning, and the layers may receive the multi-modal embeddings 116 as input. Training the model 102 and fine-tuning the model 102 for various downstream tasks is further described below. Other downstream tasks with which the model 102 may be implemented include an image or text generation system, a question-answer system, or another system that performs a natural language process task, a computer vision task, or a combination of such tasks.

The model 102 may be a model that is configured to receive text input and visual input and output a multi-modal embedding. In some embodiments, the model 102 is a machine learning model. In some embodiments, the model 102 implements one or more neural networks. In some embodiments, the model 102 is based on a pre-trained model and is fine-tuned for one or more of the downstream systems 104-110. Example pre-trained models include CLIP, MUTAN, MCAN, BUTD, ALIGN, VLBERT, VisualBERT, variations of such models, or another model. In some embodiments, the model 102 includes a language encoder for generating text embeddings for text data and a vision encoder for generating visual embeddings for visual data. As part of fine-tuning the model 102, the model 102 may have one or more layers appended to an input side or an output side of a pretrained model, or one or more parameters of the model 102 may be altered.

In the example of FIG. 1, the model 102 is illustrated in an inference stage. In the example shown, the model 102 receives text data 112 and visual data 114, and the model 102 outputs a multi-modal embedding 116. In some embodiments, the text data 112 and the visual data 114 may be sent from a component of one of the downstream systems 104-110. In some embodiments, one or more of the text data 112 or the visual data 114 may be an embedding representation of text or one or more images. An embedding may be a vector. In some embodiments, the text data 112 and the visual data 114 may overlap or be combined (e.g., as a multi-modal embedding or in another form that may represent both text and visual data). In some embodiments, a piece of input data may include both text data 112 and visual data 114. For example, an item (e.g., a retail product) may include an image and text. Both the image and text associated with the item may be input into the model 102.

In some embodiments, the text data 112 may be a string of text, such as a query, description, title, metadata, attribute, other information that may be represented as text, or a combination of textual data. In some embodiments, the text data 112 may include a plurality of attributes, and the attributes may include both a name and a value. In the retail context, for example, the text data 112 may include attributes for “item type,” “item category,” “brand,” “style,” “color,” “size,” “age,” “gender,” “season,” “price,” “availability,” and other attributes, as well as values for one or more of these attributes. In examples, the attributes may be stored as metadata. In some embodiments, the text data 112 may be transcribed audio data.

In some embodiments, the visual data 114 may be one or more images, or a data object that represents one or more images. In some embodiments, the one or more images may be stored as metadata. In some embodiments, the one or more images may be scraped from a website (e.g., a retail website).

As an example, there may be a product associated with text data (e.g., a product description, title, attributes, or other text data) and with visual data (e.g., one or more images). That product may be associated with one of the downstream systems 104-110. For instance, the recommender system 104 may determine whether to recommend the product, the search tool 106 may determine whether to select the product based on a search query, the labeling tool 108 may label attributes of the product based on its image and description, the ranking tool 110 may rank the product compared to other products based on a criterion, and so on. The multi-modal model 102 may receive text and image data for that product and output a multi-modal embedding 116 for the product to one of the downstream systems. The multi-modal embedding 116 may be a vector representation of the textual and visual data of the product, and the values of the multi-modal embedding 116 may depend on the combination of the text data and visual data.

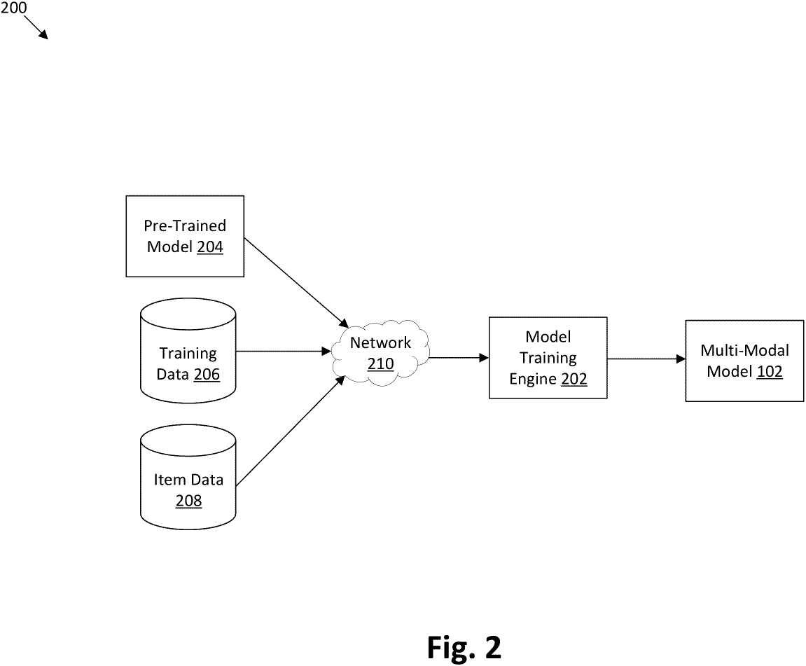

FIG. 2 illustrates an example network environment 200 for training the model 102. In the example shown, the environment 200 includes the model 102, a model training engine 202, one or more pre-trained models 204, training data 206, item data 208, and the network 210.

The model training engine 202 may, in some embodiments, be a combination of software and hardware that is configured to receive a pre-trained model and to further train or configure the pre-trained model for a downstream task. In an example, the model training engine 202 may receive the pre-trained model 204 and fine-tune the pre-trained model 204 using the training data 206 or item data 208, resulting in the multi-modal model 102. In some embodiments, the model training engine 202 may be part of another system, such as one or more of the downstream systems 104-110 of FIG. 1.

The pre-trained model 204 may be a machine learning model that has already been trained. For example, the pre-trained model 204 may be a pre-trained vision-language model. In an example, the pre-trained model 204 is an open-source model. In an example, pre-trained model 204 is trained on over one million training instances. In some embodiments, the pre-trained model 204 may be trained on data scraped from the internet. Depending on the embodiment, the architecture of the pre-trained model 204 may vary. In some embodiments, the pre-trained model 204 may use transformers. In some embodiments, the pre-trained model 204 may use a dual encoder or a fusion encoder. Furthermore, the task for which the pre-trained model 204 is trained may vary. In some embodiments, the pre-trained model 204 may be trained to perform a masked image or masked text recognition task. In some embodiments, the pre-trained model 204 may be trained using contrastive learning techniques. In some embodiments, the pre-trained model 204 may be trained on a visual question answering task. In some embodiments, the pre-trained model 204 may be trained using other techniques, such as using other self-supervised learning techniques. In some embodiments, the pre-trained model 204 is a plurality of machine learning models that have been combined or that are combined by the model training engine 202 or another component. Example pre-trained models include CLIP, MUTAN, MCAN, BUTD, ALIGN, VLBERT, VisualBERT, variations of such models, or another model.

The training data 206 may be used by the model training engine 202 to fine-tune the pre-trained model 204, resulting in the model 102. In some embodiments, the training data 206 may be labeled. The labels may correspond with the task for which the model training engine 202 is training the model 102. In some embodiments, the training data 206 is for a particular domain, thereby enabling the model training engine 202 to fine-tune the model 102 for domain-specific tasks. In some embodiments, the training data 206 is an open-source dataset.

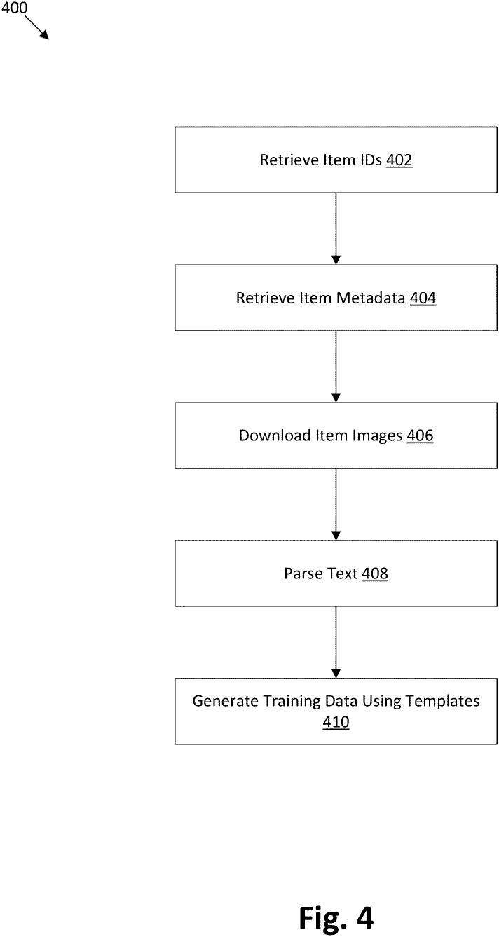

In some embodiments, the model training engine 202 may use the item data 208 to generate training data and fine-tune the model 102. The item data 208 may include text and image data for a plurality of items. In some embodiments, the plurality of items may be from a product catalog associated with an organization. The text data may include item titles, descriptions, attributes, or other data. The image data may include one or more images for a product, either alone or with other objects. In some embodiments, each of the items represented by the item data 208 is associated with an item ID. In some embodiments, the model training engine 202 may generate training instances based on the item data 208. In some embodiments, the item data 208 includes data for products sold by a retailer. In some embodiments, the item data 208 includes data for products of a particular domain (e.g., clothes or fashion-related products). An example of creating training data by using item data is illustrated and described in connection with FIG. 4.

The network 210 may be, for example, a wireless network, a wired network, a virtual network, the internet, or another type of network. Furthermore, the network 210 may be divided into subnetworks, and the subnetworks may be different types of networks or the same type of network. In different embodiments, the network environment 200 can include a different network configuration than shown in FIG. 2, and the network environment 200 may include more or fewer components than those illustrated.

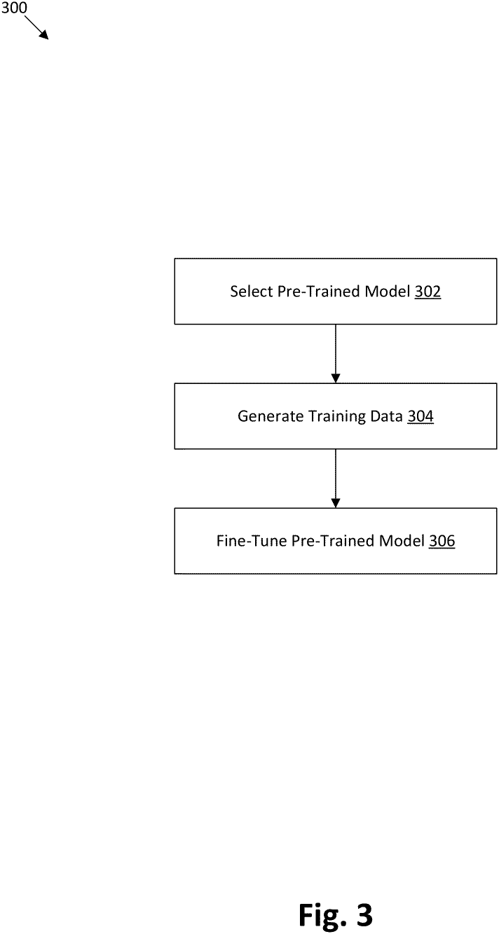

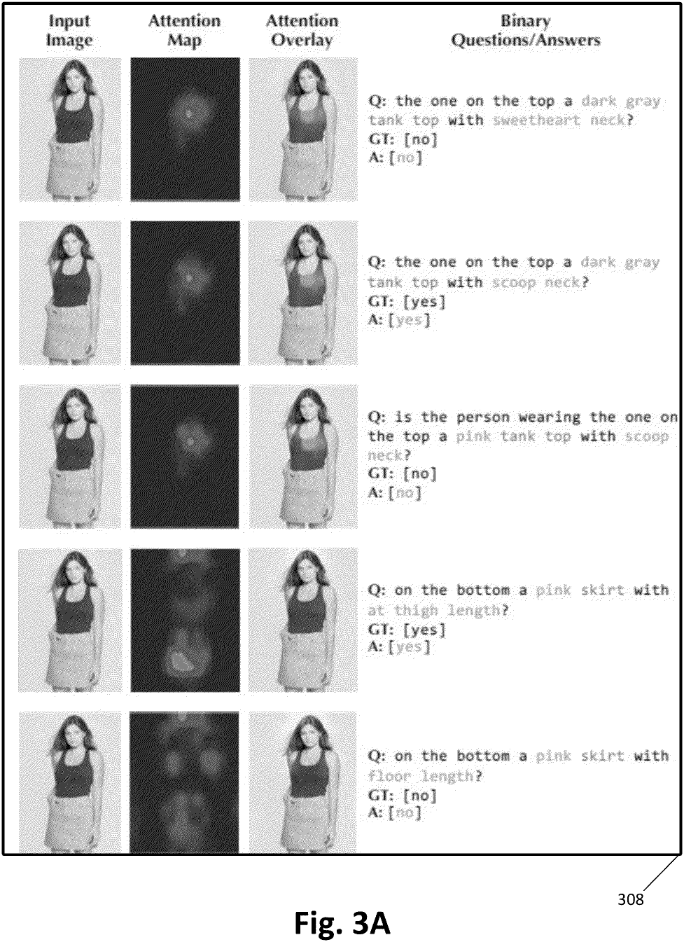

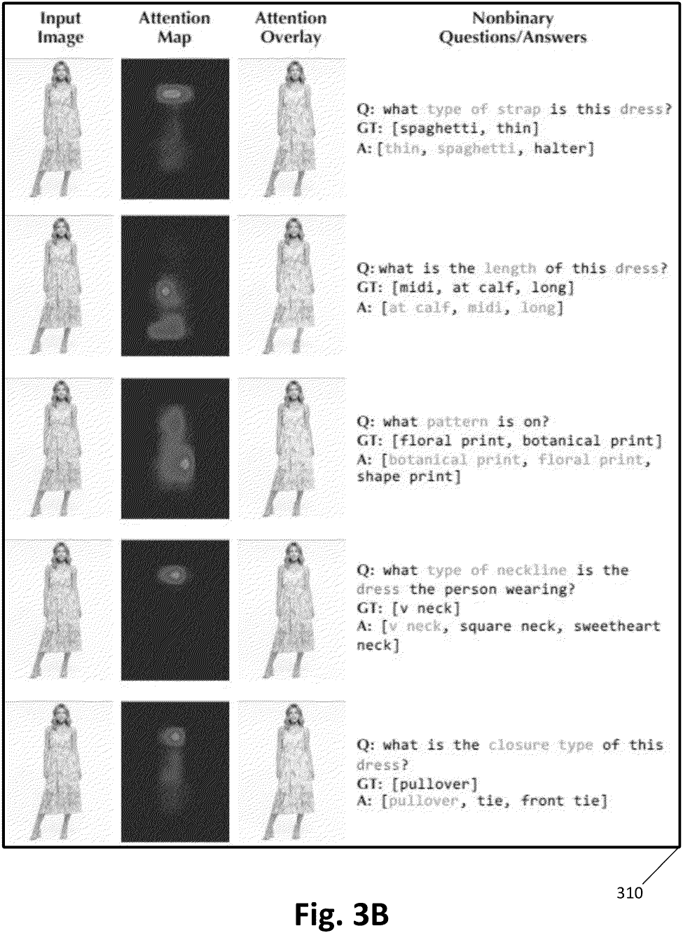

FIG. 3 is a flowchart of an example method 300 that may be used to configure the multi-modal model 102. In some embodiments, the model training engine 202 may perform the method 300. In the example shown, the model training engine 202 may select a pre-trained model (step 302). For example, the model training engine 202 may select one of the pre-trained models 204, which are described above in connection with FIG. 2. In some embodiments, the model training engine 202 may select a different pre-trained model depending on the task for which the model training engine 202 is fine-tuning the pre-trained model.

In the example shown, the model training engine 202 may generate training data (step 304). The training data may be used by the model training engine 202 as part of fine-tuning the model 102. In some embodiments, the model training engine 202 may generate training data by using the item data 208. An example of generating training data is illustrated and described below in connection with FIG. 4. In some embodiments, the model training engine 202 may retrieve training data from a database in addition to, or instead of, generating the training data.

In the example shown, the model training engine 202 may fine-tune the pre-trained model, resulting in the model 102 (step 306). The operations performed during the fine-tuning process may depend on the downstream task for which the model is being configured. In some embodiments, the model training engine 202 may fine-tune the model 102 for a particular domain. For example, the pre-trained model may be trained on a wide variety of data and may not perform well for images and texts from a particular domain. Fine-tuning the model 102 for a specific domain may include further training of the model using data from the particular domain. As a result, weights of the pre-trained model or weights in appended layers may be updated to reflect the learning from the domain-specific training data.

In some embodiments, fine-tuning the model may include adding one or more parameters to the model (e.g., input layers, output layers, hidden layers, neurons, edges, weights). In some embodiments, one or more layers may be added to the end of the pre-trained model. For example, the model training engine 202 may append one or more classification layers to the pre-trained model. In some embodiments, the model training engine 202 may append one or more layers on the input side of the pre-trained model. Such layers may result in a prefix or suffix being appended to input data. In some embodiments, weights of the pre-trained model may be frozen while weights or parameters of appended layers are adjusted so that the model is configured for a particular domain or task. In some embodiments, however, weights and parameters of the pre-trained model may also be updated as part of fine-tuning the model. In some embodiments, the model training engine 202 may iteratively fine-tune the model. For example, the model training engine 202 may train the model, validate the model, and depending on the results, continue to train the model, until a threshhold accuracy, precision, recall, or F1 score is reached. In some embodiments, the model training engine 202 may fine-tune the model using other techniques.

In some embodiments, the model training engine may train the multi-modal model 102 to perform a visual question answering task. For example, given the visual embedding of an input image and the text embedding of an input question sentence, the model may be trained to output an answer to the question. In some embodiments, the answer to a question may be tokenized and concatenated with question tokens as the language input, and a special token ‘SEP’ may be inserted between the question tokens and answer token. During training, a token may be randomly masked, and a task of the model may be to predict the masked token. In some embodiments, tokens in the answers and questions share the same word vocabulary, thereby allowing the model to work as a visual language model that benefits from an overlap in question tokens of binary questions and answer tokens of non-binary questions.

In some embodiments, during the training stage using a visual question answering task, binary-question prediction and non-binary question prediction may be treated differently. For example, they may be treated as two different tasks, and the model may output predicted answers from two different classifiers. In some embodiments, it may be verified that the model focuses its attention on a region of an image mentioned in the questions. As a result, it may be verified that the model is accounting for contextual interaction between the text embeddings and visual embeddings.

For example, FIGS. 3A-3B illustrate example visualizations 308-310 of attention of one or more intermediate layers of the multi-modal model from two validation samples for a series of binary questions, as illustrated in the visualization 308, and non-binary questions, as illustrated in the visualization 310. Each of visualizations includes a column for the input image, attention map, attention overlay, and questions/answers. The question/answers column includes questions (Q), ground truths (GT), and answers (A). As shown by the attention map, and the input image overlayed on the attention map, the multi-modal model focuses on a part of the image that is relevant to the question asked. For example, as illustrated in the visualization 308, when asked, “Is the person wearing the one on the top a pink tank top with scoop neck?” the multi-modal model appropriately focuses on the tank top of the image and whether there is a scoop neck. And when the multi-modal model is asked about the color and length of a skirt in the image, the multi-modal model appropriately focuses on the skirt. In a similar manner, the visualizations 308-310 illustrate examples of operations of an example embodiment of the multi-modal machine learning model.

FIG. 4 is a flowchart of an example method 400 for generating training data. In an example, the model training engine 202 may perform aspects of the method 400. Although described as being performed by the model training engine 202, the method 400 may also, in some embodiments, be performed by other components. In some embodiments, the model training engine 202 may perform the method using item data (e.g., the item data 208).

In the example shown, the model training engine 202 may retrieve item IDs for a plurality of items (step 402). The item IDs may be alphanumeric strings. In some embodiments, the item IDs may be stored in a location that is different than the item data. In some embodiments, the model training engine 202 may retrieve IDs only for items for a category of items. For example, if the model 102 is being fine-tuned to perform a task in the context of clothing, then the model training engine 202 may only retrieve IDs for clothing items.

In the example shown, the model training engine 202 may retrieve item metadata (step 404). For example, the model training engine 202 may retrieve metadata associated with each of the item IDs retrieved by the model training engine 202. To retrieve the item metadata, the model training engine 202 may, in some embodiments, define a data structure, and the model training engine 202 may call an API using the data structure to retrieve metadata. In some embodiments, the API is interacted with using GraphQL. The metadata may include, but is not limited to, one or more of the following: a description, one or more attributes, a title, one or more images, a URL for accessing an image, or other data related to the item.

In the example shown, the model training engine 202 may download item images (step 406). In some embodiments, the model training engine 202 may download an image for each of the item IDs retrieved by the model training engine 202. To do so, the model training engine 202 may, in some embodiments, use a URL in item metadata to download an image for each of the items. In some embodiments, one or more of the items may be associated with a plurality of images, one or more of which may be downloaded.

In the example shown, the model training engine 202 may parse item text (step 408). For example, the model training engine 202 may, for metadata retrieved for an item, parse the metadata for attributes of the item. As an example, the model training engine 202 may parse the metadata for attributes such as “Color,” “Style,” “Size,” “Title,” or other attributes or data of an item. In some instances, however, the metadata may be inconsistent across items. For example, while one item may have an attributed titled “Color,” another item may have an attribute titled “Color Name.” Likewise, in some instances, attribute fields for one item may be split or combined when compared to attribute fields for another item. In some embodiments, the model training engine 202 may account for such discrepancies in attribute names and in separating or combining attribute fields. For example, the model training engine 202 may use a configurable mapping library to detect variations in metadata and to normalize the text found in the metadata. In some embodiments, the model training engine 202 may use one or more templates as part of parsing metadata. In some embodiments, the model training engine 202 may use a machine learning model (e.g., a model trained for a natural language recognition task) to parse the text.

In the example shown, the model training engine 202 may generate training data using question templates (step 410). By doing so, the model training engine 202 may create question-answer-image triplets, which may be used to train the model 102. To fill out a question template, the model training engine 202 may use, for an item, an attribute, attribute value, category, and location. A basic template may be structured as follows: “{question type} {this/these} {a/an/} {pair of/pairs of/} {object} {location}?” In some embodiments, the model training engine 202 may loop through the item data parsed at the step 408, applying one or more templates to each set of item data, to generate a plurality of questions for each item.

In some embodiments, the model training engine 202 may increase question diversity by changing the format of a question or changing other aspects of the questions, such as the demonstratives, subject pronouns, or prepositional phrases. In some embodiments, the model training engine 202 may generate binary questions and non-binary questions. In some embodiments, the model training engine 202 may, for binary questions, generate a balance of positive and negative questions. As an example, a question may be “is this a white shirt with long sleeves?” As another example, a question may be “what color is the one on top?” In some embodiments, the model training engine 202 may generate many training instances for each item by using such question templates. Example templates and questions are illustrated below in the Table 1. However, in some embodiments, the model training engine 202 may use templates and processes other than those illustrated by Table 1.

TABLE 1

Example Question Templates and Questions

| | | | |
|---|---|---|---|
| Question templates | Answer types | Question types | Questions |
| “is this a (attr1) (category) with (attr2)?” | “yes/no” | “is/are” | “is this a white shirt with long sleeves?” |
| “on the top a (category) with (attr1) and in (attr2) design?” | “yes/no” | “is/are” | “on the top a sweater with floral print and in v neck design?” |
| “what (attribute type) is the (cat- egory) the person wearing (loca- tion)?” | “others” | “what (attribute type)” | “what color is this a-line dress the person wearing on the top?” |
| “what (attribute type) is the (location)?” | “others” | “what (attribute type)” | “what color is the one on the top?” |
| “when is a good line to wear this (attr1) (category)?” | “others” | “when” | “when is a good time to wear this yellow dress?” |

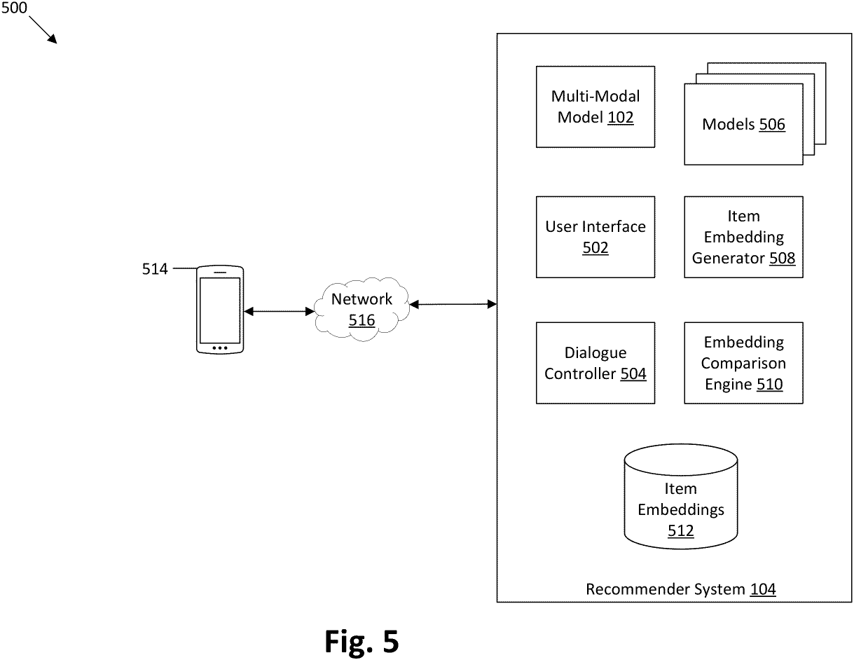

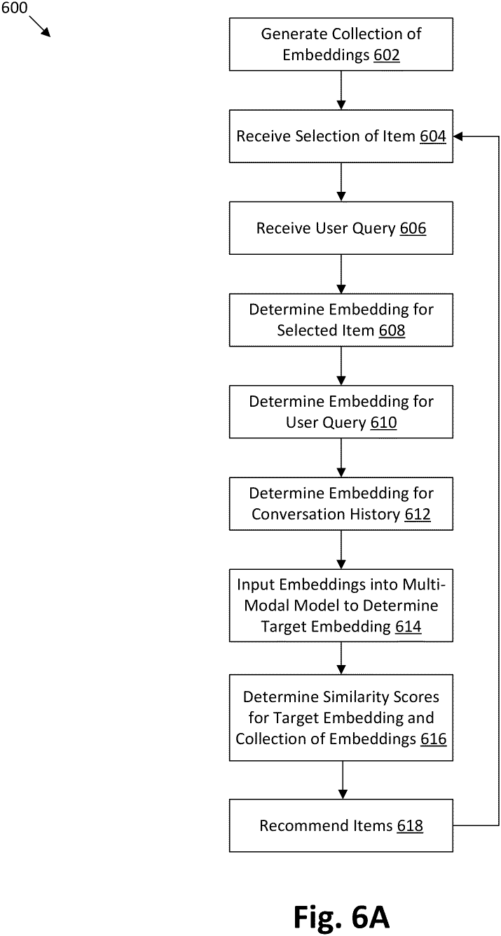

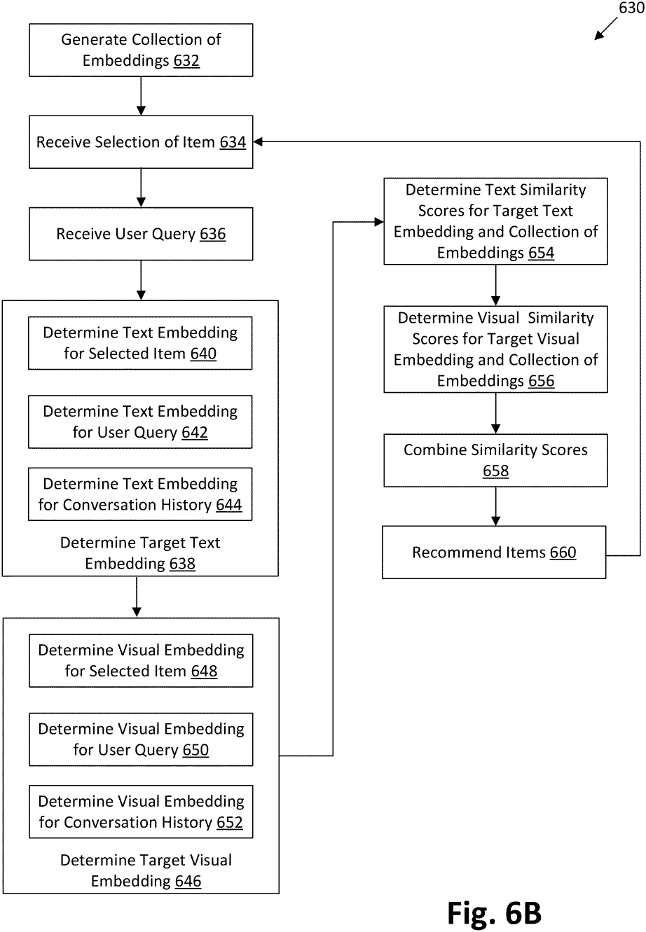

FIG. 5 illustrates an example network environment 500 in which an example recommender system 104 may be implemented. In the example of FIG. 5, the environment 500 includes the recommender system 104, a device 514, and a network 516. Example uses and aspects of the recommender system 104 are further illustrated and described below in connection with FIGS. 6-8.

In the example of FIG. 5, the recommender system 104 includes the multi-modal model 102, a user interface 502, a dialogue controller 504, models 506, an item embedding generator 508, an embedding comparison engine 510, and item embeddings 512. In some embodiments, the recommender system 104 may include more or fewer components than those illustrated in the example of FIG. 5. In some embodiments, the device 514 may access the recommender system 104 via a web browser. In some embodiments, the device 514 may access the recommender system 104 using a mobile application.

In the example of FIG. 5, the model 102 may be fine-tuned to be used in the recommender system 104. As part of the recommender system 104, the model 102 may be trained to receive inputs corresponding to one or more selected items, a user query, and one or more conversation histories. In some embodiments, the model 102 may receive these inputs as embeddings. As part of the recommender system 104, the model 102 may be configured to generate a multi-modal embedding, which may be used, either by the embedding comparison engine 510 or another component of the recommender system 104, to select one or more items to recommend, a process that is further described below.

The user interface 502 may be provided by the recommender system 104 to the device 514 in response to the device 514 access the recommender system 104. In some embodiments, the device 514 may render the user interface 502 in a web browser or mobile application. The user interface may include a chat area that displays user queries, text generated by the recommender system 104, and recommended items. The chat area may include selectable input fields, such as input fields for selecting preferred items or for clicking or touching a link that directs a user to a system for purchasing or viewing more information about an item. In some embodiments, the user interface 502 may also include a text input field, via which a user may input a query. In some embodiments, the user interface 502 may also include other features, such as a display of previous conversation sessions, help features, manipulatable filters and categories, a voice input option, a save option, an AI-assisted user query generation option, or other features.

The dialogue controller 504 may generate text that is output to a user. In some embodiments, the dialogue controller 504 may generate text based on a conversation state (e.g., based on previous user queries and other contextual information). In some embodiments, the dialogue controller 504 may be limited to generating text derived from one or more templates. In some embodiments, the dialogue controller 504 may use a large language model to generate text in response to a user query. In some embodiments, the dialogue controller 504 may also parse text that is input by a user.

The models 506 may include one or more unimodal or multi-modal that may be used by the recommender system 104. In some embodiments, such models are different from the multi-modal model 102. In some embodiments, the multi-modal model 102 may use one or more of the models 506. In some embodiments, the recommender system 104 may use a model 506 to generate embeddings for a user query, embeddings which may then be used as input for the multi-modal model 102. As another example, in some instances, the recommender system 104 may, rather than using the multi-modal model 102, use a plurality of models of the models 506 to generate embeddings that may be used to generate item recommendations. For example, the recommender system 104 may use a first set of models for generating text embeddings and a second set of models for generating visual embeddings. In some embodiments, the embeddings may be weighed and combined (e.g., added or averaged) to generate a target embedding. In some embodiments, the recommender system 104 may use a model 506 to learn and generate time-dependent weights that may be applied to different conversation states of a conversation history.

The item embedding generator 508 may facilitate the generation of embeddings for a collection of items. For example, the item embedding generator may access information for a plurality of items from a database. In some embodiments, the items may be from a product catalog. The information may include text and image data. In some embodiments, the item information may be stored in a product database associated with a retailer. In some embodiments, the item embedding generator 508 may, for each item of the collection of items, input information related to the item into the multi-modal model 102 to generate an embedding for that item. As a result, the item embedding generator 508 may generate a collection of embeddings for the collection of items. In some embodiments, these embeddings may be stored in the item embeddings database 512.

The embedding comparison engine 510 may, in some embodiments, compare a target embedding generated by the multi-modal model 102 with pre-computed item embeddings. For example, the model 102 may generate a target embedding based on a user query, one or more user-preferred items, and a conversation history. The embedding comparison engine 510 may compare the target embedding with embeddings generated for a collection of items. In some embodiments, such a comparison may be performed by determining distances in a latent feature space. In some embodiments, the embedding comparison engine 510 may determine a cosine similarity or a cosine distance between the target embedding and one or more embeddings of the collection of embeddings associated with the collection of items. In some embodiments, the embedding comparison engine 510 may select an item to recommend based on a nearness of the embedding associated with that item and the target embedding. In some embodiments, the embedding comparison engine 510 may select a certain number of items (e.g., two to four) to recommend to a user. In some embodiments, however, one or more recommended items may be selected based at least in part on factors other than nearness of embeddings in a latent feature space. For example, an item may be recommended based at least in part on an item promotion, based on a policy of promoting variety in item recommendations, or based on other considerations.

The device 514 may, in some embodiments, be a computing device. In some embodiments, the device 514 may be a mobile phone, a laptop computer, a tablet, a desktop computer, a server, or another computing device. Although illustrated as a single device 514, a plurality of devices may be coupled to the recommender system 104. Each of the plurality of devices may be associated with a user that is interacting with the recommender system 104. In some embodiments, the device 514 may access the recommender system 104 by using a web browser that calls a function of a website (e.g., a retail website) or by using a mobile application installed on the device 514.

The network 516 may be, for example, a wireless network, a wired network, a virtual network, the internet, or another type of network. Furthermore, the network 516 may be divided into subnetworks, and the subnetworks may be different types of networks or the same type of network. In different embodiments, the network environment 500 can include a different network configuration than shown in FIG. 5, and the network environment 500 may include more or fewer components than those illustrated.

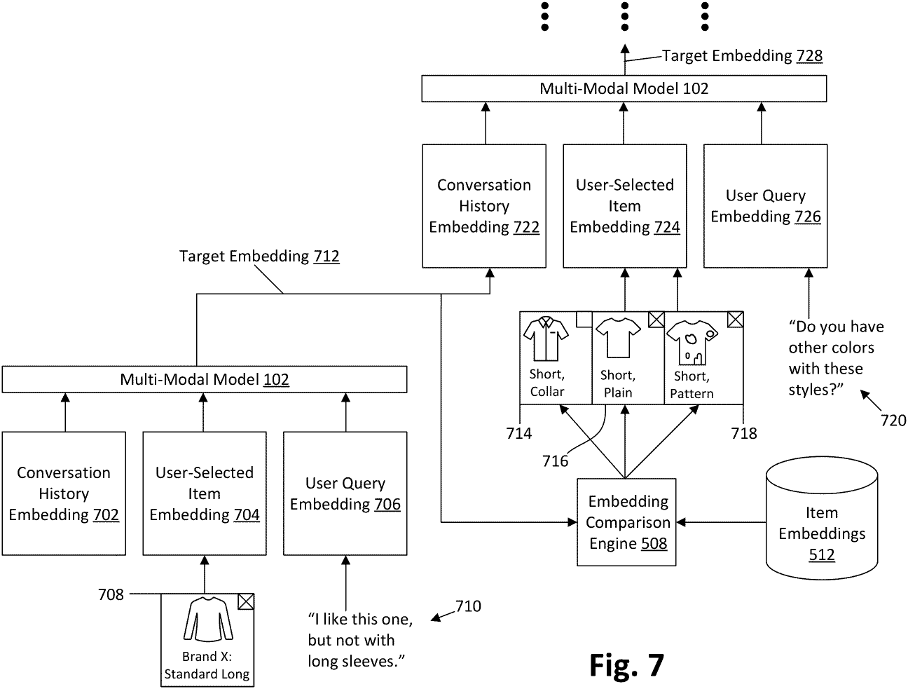

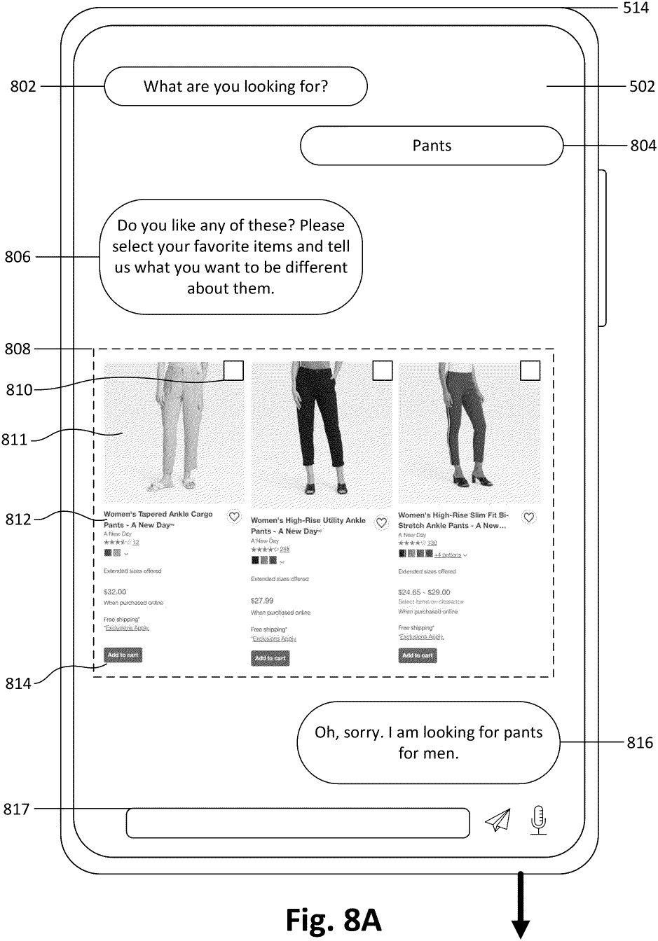

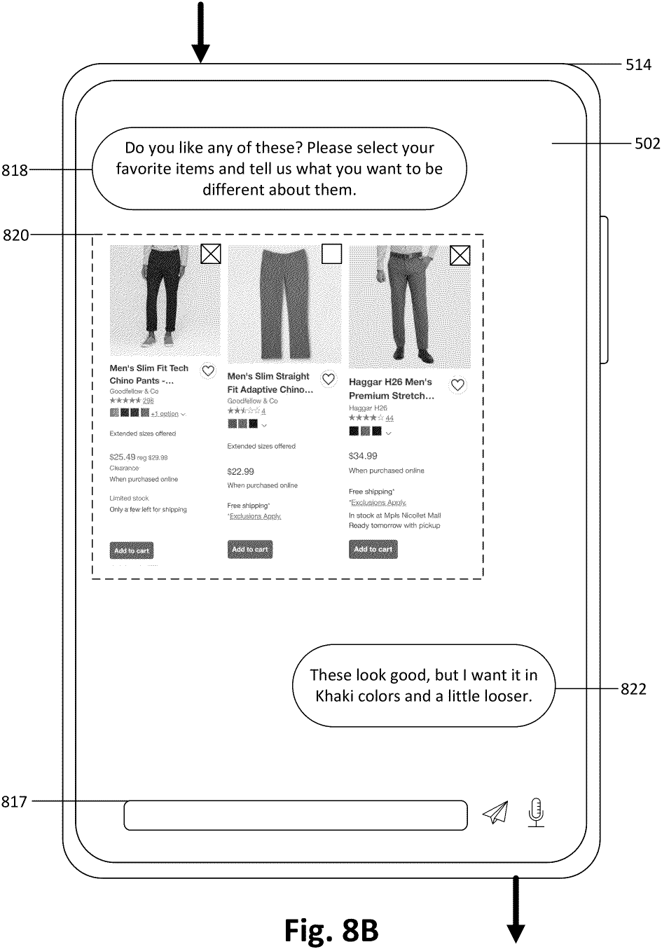

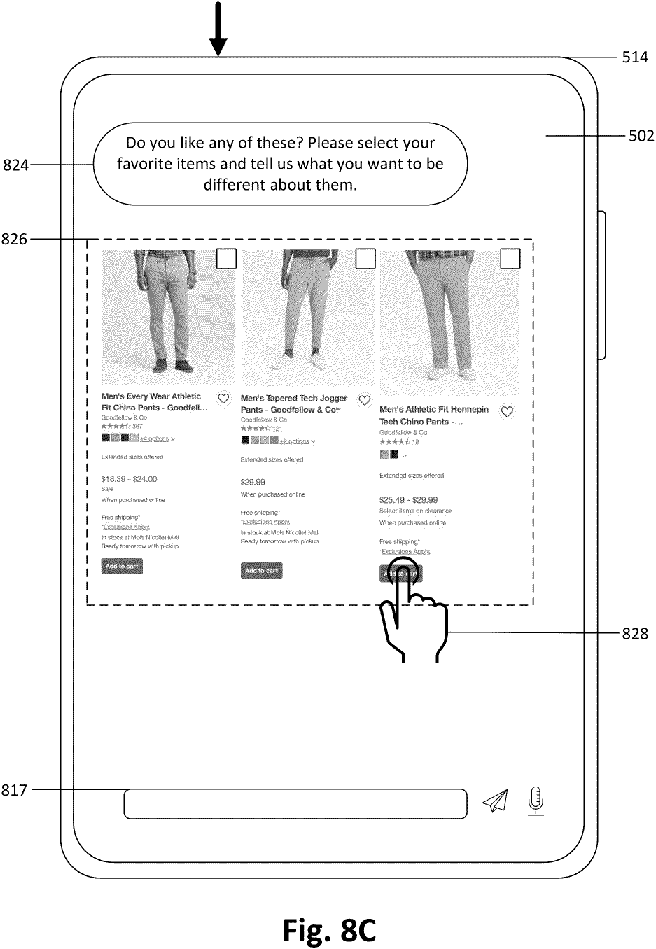

FIG. 6A is a flowchart of a method 600 that may be performed by the recommender system 104. In some embodiments, steps of the method 600 may be performed by one or more components of the recommender system 104 described above in connection with FIG. 5. Aspects and examples of the method 600 are further illustrated and described below in connection with FIGS. 7-8.

In the example shown, the recommender system 104 may generate a collection of embeddings (step 602). For example, the recommender system 104 may, for each item of a plurality of items, generate an embedding for the item using the multi-modal model 102. The plurality of items may be from a product catalog. For example, the recommender system 104 may input text and visual data for the item into the model 102, which may generate an embedding for the item. The text data may include one or more of item attributes, an item description or title, metadata, or other textual data. The visual data may include one or more images of the item. In examples, the one or more images may be stored as metadata for the item. In some embodiments, the recommender system 104 may generate an embedding for each item in a category of items (e.g., clothes, food, electronics, items available at a store, or any other category of items). In some embodiments, the recommender system 104 may generate embeddings for each item offered by a retailer. In some embodiments, the recommender system 104 may store the collection of item embeddings in a database. In some embodiments, the recommender system 104 may update the collection of embeddings. For example, the recommender system 104 may generate new item embeddings for new items, remove items embeddings if an item is discontinued, or update (e.g., recalculate) an embedding for an item in response to a change to text or visual data for an item.

In the example shown, the recommender system 104 may receive a selection of an item (or a plurality of items) (step 604). In some embodiments, the recommender system 104 may display a user interface (e.g., the user interface 502), and a user may select one or more items via the user interface. In some embodiments, the item may be displayed in the user interface, and the user may touch or click on the item, indicating that the item is selected. In some embodiments, the item may not be displayed, but an item may nevertheless be selected (e.g., by using categories, filters, or search terms). In some embodiments, a plurality of items may be selected. For example, a plurality of items may be displayed via the user interface, and the user may select two or more of the displayed items. Each of the plurality of items may include a distinct image and distinct text (e.g., the image for each item may be different than the image for the other items, and the text for each item may be different than the text for the other items). In some embodiments, the user may select items from among a plurality of items that are recommended by the recommender system 104. In some embodiments, a user indicates a preference for an item by selecting the item.

In the example shown, the recommender system 104 may receive a user query (step 606). In some embodiments, the recommender system 104 may receive the user query via a text input field of the user interface. In some embodiments, the user query may be an alphanumeric string. In some embodiments, the user query my correspond to multiple inputs from a user (e.g., the recommender system 104 may concatenate or otherwise combine multiple inputs into a user query). In some embodiments, the user query may be an audio query that may be transcribed to text. In some embodiments, the user query may refer to or otherwise be associated with the one or more items selected by the user.

In the example shown, the recommender system 104 may determine an embedding for the one or more selected items (step 608). In some embodiments, the selected item may belong to the collection of items for which the collection of embeddings was determined (e.g., at step 602). For example, the embedding for the selected may be precomputed (e.g., the embedding may have already been determined by the recommender system 104). In such instances, the recommender system 104 may select the corresponding embeddings from a database of embeddings. For example, the recommender system 104 may determine an identification of a selected item and then lookup that item in a database storing embeddings to determine the item’s embedding. In some embodiments, the recommender system 104 may generate an embedding for the selected item by inputting one or more of text or visual data into a model that generates embeddings, such as one of the models 506. When two or more items are selected, the recommender system 104 may, in some embodiments, determine an embedding for each of the selected items, and then the recommender system 104 may combine the embeddings. For example, the recommender system 104 may average the embeddings for each of the selected items.

In the example shown, the recommender system 104 may determine an embedding for the user query (step 610). To do so, the recommender system 104 may input query text into a model that generates embeddings, such as one of the models 506. In some embodiments, the recommender system 104 may input the query into a language model. In some embodiments, the recommender system 104 may input the query into T5 or Word2Vec. In other embodiments, the recommender system 104 may input the query into another model.

In the example shown, the recommender system 104 may determine an embedding for a conversation history (step 612). In some embodiments, the embedding for the conversation history may be the target embedding generated by the recommender system 104 in a previous iteration of the method 600, as illustrated in the example of FIG. 7. In some embodiments, the embedding for the conversation history may represent previous user queries and previous user-selected items. In some embodiments, the conversation history is limited to a current chat or recommendation session. In some embodiments, the conversation history includes multiple conversation states. An ith conversation state may include, for example, a user query at an ith iteration of the method 600 and recommended or user-selected items at an ith iteration of the method 600. In such instances, each conversation state may include a different embedding that represents the user queries and recommended or user-selected items at that time, or up until that time.

In the example shown, the recommender system 104 may input embeddings into the multi-modal model 102 to determine a target embedding (step 614). For example, the recommender system 104 may input the embeddings for the one or more selected items, embeddings for the user query, and embeddings for the conversational history into the model 102. Based on the inputs, the model may determine a target embedding. In some embodiments, the recommender system may, at an ith iteration, use equation (1):

$${T}_{e} \left(i\right) = M \left({T}_{e} \left(i - 1\right) , {P}_{e} \left(i\right) , {Q}_{e} \left(i\right)\right) \qquad \text{(1)}$$

Tₑ(i) may be the target embedding. M may be a model such as the multi-modal model 102. Tₑ(i - 1) may be the target embedding of the previous iteration and the embedding for the conversation history. Pₑ(i) may be the combination of embeddings for the one or more selected items. Qₑ(i) may be the embedding for the user query.

In some embodiments, the model may, rather than receiving Tₑ(i - 1) as an input embedding for the conversation history, receive a plurality of embeddings for a plurality of conversation states that constitute the conversation history. Furthermore, in some embodiments, the model 102 may determine a weighted average of the embeddings for the plurality of conversation states by applying a time-dependent weight to each of the conversation states.

For instance, in some embodiments, the inputs to the model 102 may include Tₑ(i -1), Tₑ(i - 2), Tₑ(i - 3), and so on. In some embodiments, the recommender system 104 may determine In some embodiments, the previous conversation states going back to a beginning of a conversation session may be considered. In some embodiments, less than all previous conversation states are input into the model 102 (e.g., only considering the most recent five target embeddings, or only considering the first target embedding and the most recent target embedding) In some embodiments, the embeddings representing previous conversation states may be weighed. For example, the inputs to the model 102 may include w_{i - 1}Tₑ(i - 1), wᵢ ₋₂Tₑ(i - 2), w_{i - 3}Tₑ(i - 3), and so on, for each of the previous conversation states that is considered at the ith iteration by the model 102. In some embodiments, the weights (w) may be a number or a vector. In some embodiments, the weights may be learned from a machine learning model, such as one of the models 506. For example, a model may be trained on previous conversations to determine the weights to assign to past conversation states. In an example, such conversations may be labeled, and the training may be supervised. In some embodiments, such training may be self-supervised.

In the example shown, the recommender system 104 may determine similarity scores for the target embedding and embeddings from the collection of embeddings (step 616). For example, the recommender system 104 may determine a cosine similarity between the target embedding and embeddings from the collection of embeddings in a latent feature space. In some embodiments, the recommender system 104 may determine a cosine distance between the target embedding and embeddings from the collection of embeddings. In some embodiments, the Euclidean distance between two embeddings is used to determine similarity. In some embodiments, the closer (e.g., using either cosine similarity or Euclidean distance) in the latent space that the target embedding is with an embedding from the collection of embeddings, the more similar the embeddings are. In some embodiments, the recommender system 104 may determine similarity scores using equation (2):

$$S = C o s i n e S i m i l a r i t y \left({T}_{e} \left(i\right) , A L L \text{\_} I t e m \text{\_} E m b e d d i n g s\right) \qquad \text{(2)}$$

S is a set of similarity scores between the target embedding (e.g., Tₑ(i)) and a plurality of embeddings (e.g., ALL_Item_Embeddings) generated for a plurality of items. In some embodiments, the plurality of embeddings ALL_Item_Embeddings are previously determined by the recommender system 104 using the model 102 (e.g., at the step 602).

In the example shown, the recommender system 104 may recommend items (step 618). In some embodiments, the recommender system 104 may use the set of similarity scores S to recommend items. For example, the recommender system 104 may select items having the greatest similarity score (e.g., items associated with embeddings that are nearest in the latent space to the target embedding) to recommend. In an example, the recommender system 104 may select a predetermined number of such items (e.g., as set by an administrator of the recommender system 104 or based on characteristics of the user interface, such as display size, or based on a required threshold similarity). In some embodiments, the recommender system 104 may also select items to recommend based at least in part on factors other than selecting top similarity scores. For example, in some embodiments, the recommender system 104 may select items that are not too similar to one another. For example, even if Item A and Item B have embeddings with the highest similarity scores to the target embedding, the recommender system 104 may not recommend Item B if it is too similar to Item A (e.g., if Item B is only a slight variation of Item A), as a way to promote recommendation diversity. Other factors that the recommender system 104 may consider include whether an item is being promoted, whether an item complements another item associated with a user, whether an item is a match with user profile data, or other factors.

In some embodiments, the recommender system 104 may display the recommended items via the user interface. In examples, the user interface that displays the recommended items may be the same user interface via which the user selected one or more items and input a query. In some embodiments, the display for a recommend item may include one or more images, text associated with the item, and a link or button to purchase the item or to view more information of the item. Additionally, in some embodiments, the recommender system 104 may also generate and display text in the user interface. The text may include, for example, a prompt asking the user whether the user would like to select or purchase one of the recommended items. An example of displaying recommended items via a user interface is illustrated and described below in connection with FIGS. 8A-8C.

In some embodiments, the user may select an item, enter a user query, or perform another action indicating that the user wants a further recommendation or wants to continue searching. In response, the recommender system 104 may repeat the method 600, or some operations of the method 600. In such an instance, the session will progress to an iteration of i + 1. The recommender system may update the inputs of the model 102. For example, an updated embedding may be generated for a new user query, an updated embedding may be generated for one or more user-selected items (e.g., items selected by the user from the items recommended by the recommender system at the step 618), and the conversation history input may be the target embedding generated at the ith iteration of the method 600 (e.g., at the step 614). In some embodiments, the user may select an item to purchase, in which case the session may end.

FIG. 6B is a flowchart of a method 630 that may be performed by the recommender system 104. In some embodiments, the method 630 may be used instead of or in addition to the method 600. In some embodiments, the recommender system 104 may use models other than the model 102 to perform the method 630. For example, in the method 630, the recommender system 104 may separately determine and use text and visual embeddings, rather than determining multi-modal embeddings with the model 102. In some embodiments, however, the model 102 may also be used to perform one or more operations of the method 630. In some embodiments, steps of the method 630 may be performed by one or more components of the recommender system 104 described above in connection with FIG. 5. Aspects and examples of the method 600 are further illustrated and described below in connection with FIGS. 7-8.

In the example shown, the recommender system 104 may generate a collection of embeddings (step 632). For example, the recommender system 104 may generate a collection of embeddings for a collection of items, such as items from a product catalog. In some embodiments, the collection of items may be the same collection of items described above in connection with the step 602 of the method 600. In some embodiments, the recommender system 104 may generate separate text embeddings and visual embeddings for one or more items of the collection of items. In some embodiments, the recommender system 104 may use one or more of the models 506 to generate text embeddings and one or more of the models 506 to generate the visual embeddings.

In the example shown, the recommender system 104 may receive a selection of an item (step 634). For example, as described above in connection with the step 604 of the method 600, the recommender system 104 may receive a selection of one or more items via a user interface. The one or more items may include both text and visual data.

In the example shown, the recommender system 104 may receive a user query (step 636). As describe above in connection with the step 606 of the method 600, the recommender system 104 may receive, via a user interface, a user query, which may be a text string.

In the example shown, the recommender system 104 may determine a target text embedding (step 638). To do so, the recommender system 104 may, in some embodiments, determine text embeddings for the one or more selected items (step 640), the user query (step 642), and the conversation history (step 644). In some embodiments, the recommender system 104 may look up the text embeddings for the one or more selected items in an embedding database if the text embeddings for the one or more selected embeddings were already determined (e.g., at the step 632). In some embodiments, the recommender system 104 may determine the text embeddings for the user query by using a language model. For example, the recommender system 104 may use the T5-XL language model to determine the text embedding for the user query. In some embodiments, the recommender system 104 may use a prior target text embedding as the text embedding for the conversation history.

Having performed the steps 640-644, the recommender system 104 may combine the text embeddings for the one or more selected items, the user query, and the conversation history. To do so, the recommender system 104 may, in some embodiments, apply a weight to one or more of the text embeddings. Furthermore, the recommender system 104 may, having applied the weights, add the weighed embeddings. In some embodiments, the recommender system 104 may use equation (3) to determine the target text embedding, at an ith iteration:

$${T}_{{e}_{t e x t}} \left(i\right) = {w}_{1} ∗ {T}_{{e}_{t e x t}} \left(i - 1\right) + {w}_{2} ∗ {P}_{{e}_{t e x t}} \left(i\right) + {w}_{3} ∗ {Q}_{{e}_{T 5}} \left(i\right) \qquad \text{(3)}$$

Tₑₜₑₓₜ(i) is the target text embedding. Tₑₜₑₓₜ(i - 1) is a text embedding for the conversation history and the target text embedding for the previous iteration. Q_{eT5} (i) may be a text embedding generated for the user query. Pₑₜₑₓₜ(i) may be a mean text embedding for user-selected or user-preferred items. The weights w₁₋₃ may be numbers or vectors. In some embodiments, the recommender system 104 may learn values for the weights by using one or more of the models 506.

In the example shown, the recommender system 104 may determine a target visual embedding (step 646). To do so, the recommender system 104 may, in some embodiments, determine visual embeddings for the one or more selected items (step 648), the user query (step 650), and the conversation history (step 652). In some embodiments, recommender system 104 may look up the visual embeddings for the one or more selected items in an embedding database if the visual embeddings for the one or more selected embeddings was already determined (e.g., at the step 632). In some embodiments, the recommender system 104 may determine the visual embeddings for the user query by using a model. For example, the recommender system 104 may use the CLIP multimodally-trained text encoder, or another model that may generate visual embeddings. In some embodiments, the recommender system 104 may use a prior target visual embedding as the visual embedding for the conversation history.

Having performed the steps 648-652, the recommender system 104 may combine the visual embeddings for the one or more selected items, the user query, and the conversation history. To do so, the recommender system 104 may, in some embodiments, apply a weight to one or more of the visual embeddings. Furthermore, the recommender system 104 may, having applied the weights, add the weighed embeddings. In some embodiments, the recommender system 104 may use equation (4) to determine, at an ith iteration, the target visual embedding:

$${T}_{{e}_{c l i p \text{\_} v i s u a l}} \left(i\right) = {w}_{1} ∗ {T}_{{e}_{c l i p \text{\_} v i s u a l}} \left(i - 1\right) + {w}_{2} ∗ {P}_{{e}_{c l i p \text{\_} v i s u a l}} \left(i\right) + {w}_{3} ∗ {Q}_{{e}_{C L I P \text{\_} L}} \left(i\right) \qquad \text{(4)}$$

T_{eclip_visual} (i) is the target visual embedding. T_{eclip_visual}(i - 1) is a visual embedding for the conversation history and the target visual embedding for the previous iteration. P_{eclip_visual}(i) may be a mean text embedding for user-selected or user-preferred items. Q_{eCLIP_L}(i) may be a text embedding generated for the user query. The weights w₁₋₃ may be numbers or vectors. In some embodiments, the recommender system 104 may learn values for the weights w₁₋₃. In some embodiments, the weights w₁₋₃ of the equation (4) may correspond with the weights w₁₋₃ of the equation (3). In some embodiments, the weights w₁₋₃ of the equation (4) may be different than the weights w₁₋₃ of the equation (3).

In the example shown, the recommender system 104 may determine text similarity scores for the target text embedding and embeddings from the collection of embeddings (step 654). To do so, the recommender system 104 may, in some embodiments, compare the target text embedding with embeddings from the collection of embeddings in a latent feature space. For example, the recommender system 104 may determine a cosine similarity or a cosine distance between the target text embeddings and one or more text embeddings generated for items of the collection of items. As another example, the recommender system 104 may determine a Euclidean distance between the target text embedding and one or more of the text embeddings generated for items of the collection of items. In some embodiments, the recommender system 104 may use the following equation (5) to determine text similarity scores:

$$\begin{matrix}{S}_{t e x t} = \\ C o n s i n e S i m i l a r i t y \left({T}_{{e}_{t e x t}} \left(i\right) , A L L \_ I T E M \_ T E X T \_ E m b e d d i n g\right)\end{matrix} \qquad \text{(5)}$$

Sₜₑₓₜ are text similarity scores. Sₜₑₓₜ may include a plurality of similarity scores, such as a text similarity score for each of a plurality of items of the collection of items. ALL_ITEM_TEXT_Embedding may be the collection of text embeddings generated for the collection of items (e.g., at the step 632).

In the example shown, the recommender system 104 may determine visual similarity scores for the target visual embedding and embeddings from the collection of embeddings (step 656). To do so, the recommender system 104 may, in some embodiments, compare the target visual embedding with embeddings from the collection of embeddings in a latent feature space. For example, the recommender system 104 may determine a cosine similarity or a cosine distance between the target visual embeddings and one or more visual embeddings generated for items of the collection of items. As another example, the recommender system 104 may determine a Euclidean distance between the target visual embedding and one or more of the visual embeddings generated for items of the collection of items. In some embodiments, the recommender system 104 may use the following equation (6) to determine visual similarity scores:

$$\begin{matrix}{S}_{c l i p \text{\_} v i s u a l} = \\ C o n s i n e S i m i l a r i t y \left({T}_{{e}_{t e x t}} \left(i\right) , A L L \text{\_} I T E M \text{\_} V i s u a l \text{\_} E m b e d d i n g\right)\end{matrix} \qquad \text{(6)}$$

S_{clip_visual} are visual similarity scores. S_{clip_visual} may include a plurality of similarity scores, such as a visual similarity score for each of a plurality of items of the collection of items. ALL_ITEM_Visual_Embedding may be the collection of visual embeddings generated for the collection of items (e.g., at the step 632).

In the example shown, the recommender system 104 may combine similarity scores (step 658). For example, the recommender system 104 may combine text similarity scores and visual similarity scores, resulting in overall similarity scores that may include, for each item of the collection of items, a similarity score with the target embeddings. In some embodiments, the text and visual similarity scores may also be weighed. In some embodiments, the recommender system 104 may use the equation (7) to combine similarity scores:

$$S = {w}_{4} ∗ {S}_{t e x t} + {w}_{5} ∗ {S}_{c l i p \text{\_} v i s u a l} \qquad \text{(7)}$$

S is the set of overall similarity scores. The weights w₄₋₅ may be numbers or vectors. In some embodiments, the recommender system 104 may use a model to learn the weights w₄₋₅.

In the example shown, the recommender system 104 may recommend items (step 660). In some embodiments, the recommender system 104 may use the set of similarity scores S to select one or more items from the collection of items to recommend. An example of recommending items and selecting items to recommend is described above in connection with the step 618 of the method 600. In some embodiments, the recommender system 104 may display the one or more recommended items to a user via a user interface.

As shown in the example of FIG. 6B, the recommender system 104 may repeat aspects of the method 630. For example, the recommender system 104 may receive a selection of another item (which may, in some embodiments, be one of the recommended items) or the recommender system 104 may receive another user query. In such instances, the recommender system 104 may repeat aspects of the method 630 (e.g., in response to receiving one or more of a query or selected item, the recommender system 104 may determine embeddings and select one or more additional items to recommend), as illustrated in the example of FIG. 6B.

FIGS. 7-8 illustrate example operations of the recommender system 104. Aspects in the examples of FIGS. 7-8 illustrate example operations of the methods 600 and 630.

Referring to the schematic example operation of the recommender system 104 depicted in FIG. 7, the multi-modal model 102 may receive, as input, a conversation history embedding 702, a user-selected item embedding 704, and a user query embedding 706. In some instances, there may not be a conversation history embedding, such as when a user first begins a session with the recommender system 104. The user-selected item embedding 704 may be an embedding generated for the selected item 708. In some instances, a user may have selected the item 708 via a user interface. In some embodiments, the selected item 708 may have been recommended by the recommender system 104 to the user during a previous iteration. In some embodiments, the user-selected item embedding 704 may have been previously determined by the model 102 and may be stored in the item embeddings 512. In some embodiments, the user-selected item embedding 704 may be generated by one of the models 506 of the recommender system 104. The user-selected item embedding 704 may reflect both visual data of the item 708 (e.g., one or more images) and textual data of the item 708 (e.g., a title, description, metadata including attributes, etc.).

The user query embedding 706 may be an embedding for the user query 710. In some embodiments, the recommender system 104 may receive the user query 710 via a user interface, and the user may have sent the user query in connection with the selection of the item 708. In some embodiments, one of the models 506 may generate the user query embedding for the user query 710.

Based on the inputs 702-706, the model 102 may output the target embedding 712. In the example shown, the target embedding 712 may be provided to the embedding comparison engine 510, and the target embedding 712 may be set as the conversation history embedding 722 as an input for a next iteration and inference of the model 102.

The embedding comparison engine 510 may receive the target embedding 712 and compare it to item embeddings in the item embedding database, as is further described above, for example, in connection with the step 616 of FIG. 6. Based at least in part on the comparison, one or more items may be selected to recommend to the user. In the example shown, the items 714, 716, and 718 are recommended. Similar to the item 708, each of the items 714-718 is a shirt, but they do not have long sleeves, illustrating that the target embedding 712 generated by the model 102 accounted for the user query 710 which indicated that long sleeves were not wanted. In some embodiments, aspects of each of the recommended items 714-718 may be displayed to a user (e.g., via a user interface). As shown in the upper-right corner of each of the recommended items 714-718, a user may be able to select one or more of the recommended items as part of communicating with the recommender system. Yet still, in some embodiments, each of the recommended items 714-718 may also be associated with other interactive components, such as a button or input field to purchase the item. In the example of FIG. 7 a user selects the item 716 and the item 718, and the user inputs the user query 720.

As mentioned above, the conversation history embedding 722 may be the target embedding generated by the model 102 in the previous iteration (e.g., the target embedding 712). As a result, the conversation state, which may include the user queries and the recommended or user-preferred items, may be passed from iteration to iteration, thereby giving the recommender system 104 a mechanism for remembering previous data from the session. In examples, the conversation history embedding 722 may include not only the target embedding 712, but may also include a target embedding for an iteration prior to the iteration in which the model 102 generated the target embedding 712. As discussed above, the one or more target embeddings that represent one or more conversation states of the conversation history may be weighed (e.g., giving a higher weigh to target embeddings generated in more recent iterations than to target embeddings generated during other iterations).

The user-selected item embedding 724 may be an embedding that represents each of the user-selected items (e.g., the item 716 and 718). In some embodiments, the embeddings for the selected items 716-718 may be averaged. In other embodiments, the embeddings for the selected items 716-718 may be combined in a different manner. An example of determining embeddings for the selected items 716 and 718 is described above in connection with the step 608 of FIG. 6. The user query embedding 726 may be an embedding for the user query 720. An example of determining an embedding for the user query 720 is described above in connection with the step 610 of FIG. 6.

In the example of the FIG. 7, the model 102 may receive the inputs 722-726 and output the target embedding 728. Similar to the target embedding 712, the target embedding 728 may be used in a following iteration of the method 600 or 630 (e.g., the target embedding 728 may be used to recommend additional items and as an embedding for conversation history).

FIGS. 8A-8C illustrate a further example use of aspects of the recommender system 104. The examples of FIGS. 8A-8C depict a single recommendation session, as illustrated by the bold arrows leading to and from the device 514. In the example of FIGS. 8A-8C, a user of the device 514 may access the recommender system 104, and the recommender system 104 may provide the user interface 502, which may be displayed by a screen of the device 514. With respect to the dialogue illustrated in the examples of FIGS. 8A-8C, text from the recommender system 104 is illustrated on the left side of the user interface 502, and user queries are illustrated on the right side of the user interface 502. Furthermore, in the examples shown, a user may input queries using the input field 817. In some embodiments, the user queries may use a physical or digital keyboard to type text into the input field 817. In some embodiments, a user may use a microphone of the device 514 to input an audio query.

In FIG. 8A, the recommender system 104 may output the text 802 at the beginning of a recommendation session. As shown, the text 802 may be a prompt, asking “What are you looking for?” to the user. In other examples, the recommender system 104 may generate other text to begin a recommendation session. In the example shown, the user may input the user query 804, indicating that the user is looking for “Pants.”

In some embodiments, the recommender system 104 may select one or more items to recommend based on the user query 804. For instance, at the start of a recommendation session, there may not be any selected user-preferred items, and there may not be a conversation history. In some embodiments, the recommender system 104 may generate an embedding for the user query 804-as described, for example, in connection with the step 610 of FIG. 6-and then input the embedding for the user query 804 into the model 102. In some embodiments, the recommender system 104 may use another model or process for recommending items when there is no conversation history or no selected user-preferred items.

Continuing with the example of FIG. 8A, the recommender system 104 may, in response to the user query 804, recommend the items 808. In the example of FIG. 8A, the items 808 include three items, each of which are pants for women. In addition to displaying the items 808, the recommender system 104 may also output the text 806. In some embodiments, the dialogue controller 504 may output the text 806 based on a template. In other embodiments, the dialogue controller 504, or another component, may generate and output text by using a large language model.

In the example of FIG. 8A, although labeled for only the left-most item, each of the items 808 includes a selection field 810, an image 811, text 812, and a link 814 to add an item to an online or digital shopping cart. The selection field 810 may be clicked or touched by the user as part of interacting with the recommender system 104 to determine more refined recommendations. The text 812 may include a description and title of the item. Furthermore, although not illustrated, each of the items may include attributes. The attributes may be metadata for the item. In some embodiments, a selection of the link 814 will add the corresponding item to an online shopping cart. In some embodiments, a selection of the link 814 will direct a user to a check out process. The user query 816 indicates that the user wants to receive more recommendations. As shown, the user did not select any of the items 808 as part of continuing to search for more recommendations.

The example of FIG. 8B follows from the example of FIG. 8A. As shown in FIG. 8B, the recommender system 104 determines new items 820 to recommend based on, for example, the user query 816 and a target embedding used to select the items 808. Additionally, the recommender system 104 also generates and displays the text 818. As shown, the user selects two items of the items 820 (as illustrated by the ‘X’s in the upper-right corner of two of the recommended items 820) and inputs a user query 822.

In some embodiments, the recommender system 104 may, using the selected items of the items 820, the user query 822, and the conversation history, determine an updated set of recommendations. For example, as shown, in the example of FIG. 8C, the recommender system 104 may recommend the items 826. Along with the recommended items 826, the recommender system 104 may also output the text 824. In the example shown, the user may purchase one or more of the recommended items. For example, as shown by the selection (e.g., click or touch) of the right-most item of the items 826, the user may select a button or purchase link to add the item to an online shopping cart.

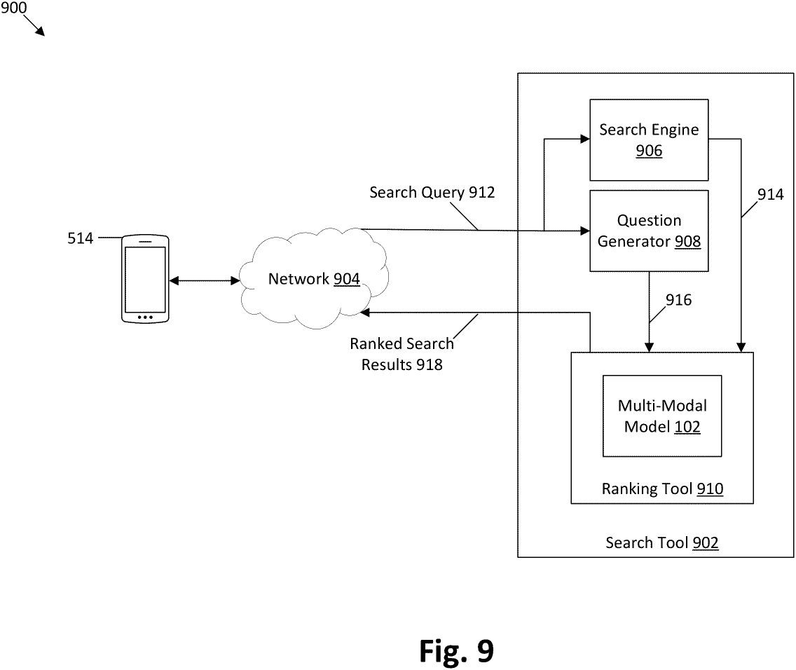

In the example of FIG. 9, the multi-modal model 102 is integrated with a search tool 902. Specifically, the model 102 is fine-tuned to rank search results by performing a visual question answer task for items of the search results.

FIG. 9 illustrates an example network environment 900 in which a search tool 902 may be implemented. The environment 900 includes the device 514, the search tool 902, and a network 904.

The search tool 902 includes a search engine 906, a question generator 908, and a ranking tool 910, which may use the model 102. In some embodiments, the search tool 902 may be accessed via a website or a mobile application. For example, a search feature offered by a website or mobile application may call the search tool 902 to perform a search in response to receiving a user query. The search engine 906 may be a system or service that receives a query and returns one or more results. In some embodiments, the search engine 906 may return one or more retail items. The question generator 908 may receive a search query and generate one or more questions based on the query. For example, if the query is “crewneck green shirts,” then the question generator may generate the following question: “what is the color of the shirt?”; “what is the person wearing on top?”; “what is the collar style of the apparel?”; “is the color green?”; “is the color red?”; and so on, generating binary and non-binary questions that may relate to the query. In examples, the question generator 908 may also generate answers for each of the question. For example, for the question “what is the collar style of the apparel,” the answer may be “crew neck,” based on the search query received by the question generator 908. As another example, for the question “is the color red,” the answer may be “no” or “false.” In an example, the question generator 908 may use one or more question templates used to create question-answer-image triplets as part of generating training data from training instances. The ranking tool 910 may rank search results. To do so, the ranking tool 910 may include one or more components, such as the multi-modal model 102.

The elements 912-918 illustrate an example use of the search tool 902. In the example shown, a user of the device 514 may provide a search query 912 to the search tool 902. In the example shown, the search query 912 may be directed to both the search engine 906 and the question generator 908. The search engine 906 may perform a search operation using the search query and generate a plurality of search results 914. The plurality of search results 914 may be a plurality of search items returned in response to the search query 912. In the example shown, the search engine 906 may provide the search results 914 to the ranking tool 910. In the example shown, the question generator 908 may receive the search query 912, generate a plurality of question 916 using the search query 912, and provide the plurality of questions to the ranking tool 910. In examples, the question generator 908 may also generate answers for each of the question. The answers may be based on the search query received by the question generator 908, and the question generator 908 may provide the answers along with the questions to the ranking tool 910.

In some embodiments, the ranking tool 910 may receive the search results 914 and the questions 916, and the ranking tool 910 may rank the search results 914 using the model 102. To do so, the model 102 may perform a visual question answering task using the search results 914 and the questions 916. For example, the model 102 may, for each item of the search results 914, answer the questions 916. With each answer, the model 102 may generate a confidence score. For each item, the confidence scores for each of the questions 916 may be averaged. The average confidence score for an item of the results 914 may be compared to confidence scores of other items of the 914, and the items may be ranked based on the confidence scores. For example, if the model 102 has a relatively high average confidence score when answering the questions 916 for an item, then that item may be ranked higher than an item for which model 102 did not have such a confidence score. In some embodiments, the confidence scores and the model 102 may be used in a different manner for ranking the search results 914. In the example shown, the search tool 902 may provide ranked search results 918 to the device. In some embodiments, the ranked search results 918 may be one or more of the items in the results 914, ranked according to an order determined by the ranking tool 910. In some embodiments, the ranked search results 918 may be displayed in a user interface of the device 514.

The network 904 may be, for example, a wireless network, a wired network, a virtual network, the internet, or another type of network. Furthermore, the network 904 may be divided into subnetworks, and the subnetworks may be different types of networks or the same type of network. In different embodiments, the network environment 900 can include a different network configuration than shown in FIG. 9, and the network environment 900 may include more or fewer components than those illustrated.

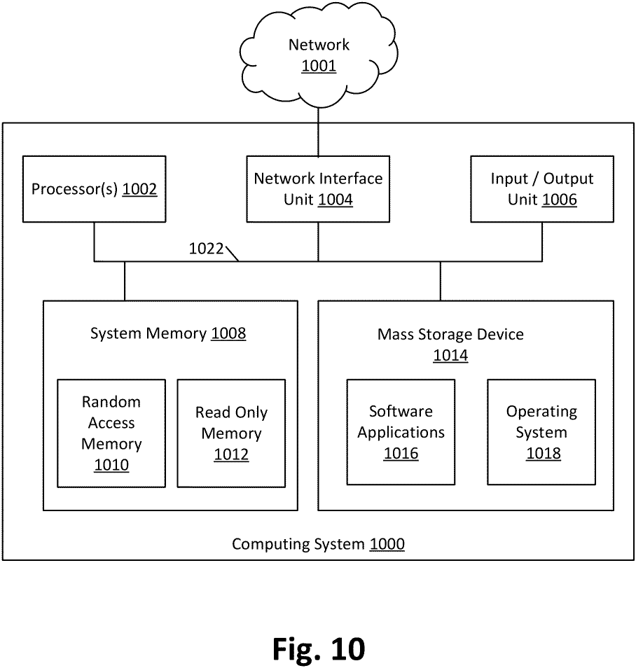

FIG. 10 illustrates an example block diagram of a virtual or physical computing system 1000. One or more aspects of the computing system 1000 can be used to implement the processes described herein.

In the embodiment shown, the computing system 1000 includes one or more processors 1002, a system memory 1008, and a system bus 1022 that couples the system memory 1008 to the one or more processors 1002. The system memory 1008 includes RAM (Random Access Memory) 1010 and ROM (Read-Only Memory) 1012. A basic input/output system that contains the basic routines that help to transfer information between elements within the computing system 1000, such as during startup, is stored in the ROM 1012. The computing system 1000 further includes a mass storage device 1014. The mass storage device 1014 is able to store software instructions and data. The one or more processors 1002 can be one or more central processing units or other processors.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments of the invention, the computing system 1000 may operate in a networked environment using logical connections to remote network devices through the network 1001. The network 1001 is a computer network, such as an enterprise intranet and/or the Internet. The network 1001 can include a LAN, a Wide Area Network (WAN), the Internet, wireless transmission mediums, wired transmission mediums, other networks, and combinations thereof. The computing system 1000 may connect to the network 1001 through a network interface unit 1004 connected to the system bus 1022. It should be appreciated that the network interface unit 1004 may also be utilized to connect to other types of networks and remote computing systems. The computing system 1000 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1000 can store software instructions and data. The software instructions include an operating system 1018 suitable for controlling the operation of the computing system 1000. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to receive and execute managing network access control and build system processes.

In examples, the disclosed computing system provides a physical environment within which aspects of the present disclosure may be implemented. For example, the computing system may represent a computing system with which the multi-modal model be trained or be used for inference, or a computing system on which the data set is generated. Additionally, the example computing system may form a portion of a computing environment within a retail enterprise, for example which may implement a retail website that receives search queries that in turn may be reformulated as visual questions that may be answered using such a trained model.

Overall, the visual question answering data set improves the speed with which a visual question answering model may be deployed in a particular context, such as within the context of fashion items. Additionally, the trained model using such a data set may provide a highly accurate query results generation model, for example for generating item recommendations to be presented to customers on the retail website. Such a trained model may be used in a variety of other applications within a retail or shopping context as well.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method for recommending items, the method comprising:
generating, using a multi-modal machine learning model, a collection of embeddings for a collection of items;
receiving a selection of an item, the item including an item image and item text;
receiving a user query;
determining a first embedding for the selected item based at least in part on the item image and the item text;
determining a second embedding for the user query;
determining a third embedding for a conversation history, the conversation history including a previous user query and a previously selected item;
inputting the first embedding, the second embedding, and the third embedding into the multi-modal machine learning model to generate a target embedding;
determining similarities between the target embedding and embeddings of the collection of embeddings; and
based on the similarities, recommending an item of the collection of items.

2. The method of claim 1, further comprising:
receiving a selection of the recommended item;
receiving a second user query;
determining a fourth embedding for the selected recommended item;
determining a fifth embedding for the second user query;
inputting the target embedding, the fourth embedding, and the fifth embedding into the multi-modal machine learning model to generate a second target embedding;
determining second similarities between the second target embedding and the embeddings of the collection of embeddings;
based on the second similarities, recommending an additional item of the collection of items.

3. The method of claim 1,
wherein receiving the selection of the item comprises receiving a selection of a displayed item via a user interface; and
wherein receiving the user query comprises receiving a text string via a text input field of the user interface.

4. The method of claim 1,
wherein the selected item belongs to the collection of items; and
wherein determining the first embedding for the selected item comprises selecting a precomputed embedding from the collection of embeddings.

5. The method of claim 1, further comprising, prior to generating the collection of embeddings for the collection of items, fine-tuning the multi-modal machine learning model.

6. The method of claim 5,
wherein fine-tuning the multi-modal machine learning model comprises adding a plurality of parameters to the multi-modal machine learning model; and
updating the plurality of parameters by training the multi-modal machine learning model using domain-specific training data.

7. The method of claim 6, wherein the domain-specific training data is labeled fashion data.

8. The method of claim 1,
wherein receiving the selection of the item comprises receiving a selection of a plurality of items, each of the plurality of items including a distinct item image and distinct item text; and
wherein determining the first embedding for the selected item comprises:
determining a plurality of first embeddings, each embedding of the plurality of first embeddings corresponding to an item of the plurality of selected items; and
averaging the plurality of first embeddings.

9. The method of claim 1, wherein the multi-modal machine learning model is based on a pre-trained visual language machine learning model.

10. The method of claim 1, wherein determining the similarities between the target embedding and embeddings of the collection of embeddings comprises determining, in a latent feature space, a cosine similarity between the target embedding and at least some of the embeddings of the collection of embeddings.

11. The method of claim 1, wherein the item text includes attributes of the item.

12. The method of claim 1, wherein the conversation history includes a plurality of previous conversation states.

13. The method of claim 12, wherein determining the third embedding for the conversation history comprises:
determining a plurality of conversation state embeddings by determining an embedding for each conversation state of the conversation history; and
determining a weighted average of the plurality of conversation state embeddings, the weighted average including a time-dependent weight applied to each conversation state of the plurality of conversation state embeddings.

14. A recommender system comprising:
a multi-modal machine learning model;
a processor; and
memory storing instructions that, when executed by the processor, cause the recommender system to:
generate, using the multi-modal machine learning model, a collection of embeddings for a collection of items;
display a user interface;
receive a selection of an item via the user interface;
receive a user query via the user interface;
select, from the collection of embeddings, a first embedding for the selected item;
determine a second embedding for the user query;
determine a third embedding corresponding to a conversation history, the third embedding being a previous target embedding;
input the first embedding, the second embedding, and the third embedding into the multi-modal machine learning model to generate a target embedding;
determine similarities between the target embedding and embeddings of the collection of embeddings; and
based on the similarities, recommend an item of the collection of items;
display the recommended item via the user interface.

15. The system of claim 14, wherein the instructions, when executed by the processor, further cause the recommender system to:
generate a set of training data; and
fine-tune, using the set of training data, the multi-modal machine learning model prior to generating, using the multi-modal machine learning model, a collection of embeddings for the collection of items.

16. The system of claim 15, wherein generating the set of training data comprises:
for each item of a plurality items, determine item attributes;
for each item of the plurality of items, accessing one or more images of the item; and
for each item of the plurality of items, generating a plurality of training instances, each of the training instances including at least one of the one or more images, a question determined by inputting at least some of the item attributes into a question template, and an answer to the question.

17. The system of claim 16, wherein the plurality of items are fashion items.

18. The system of claim 14,
wherein displaying the recommended item via the user interface comprises displaying a purchase link associated with the recommended item; and
wherein the instructions, when executed by the processor, further cause the recommender system to:
receive a selection of the purchase link via the user interface; and
in response to the selection of the purchase link, add the recommended item to a digital shopping cart.

19. A multi-modal machine learning system comprising:
a processor; and
a memory storing instructions that, when executed by the processor, cause the multi-modal machine learning system to:
generate labeled domain-specific training data based at least in part on data from a product catalog;
train a multi-modal machine learning model using the labeled domain-specific training data;
receive text data and visual data;
generate, using a language encoder, text embeddings for the text data;
generate, using a visual encoder, visual embeddings for the visual data;
input the text embeddings and the visual embeddings into the multi-modal machine learning model;
receiving, from the multi-modal machine learning model, multi-modal embeddings corresponding to the text data and the visual data; and
inputting the multi-modal embeddings into a task-specific output layer associated with a downstream system.

20. The system of claim 19, wherein the downstream system is a recommender system.
